(19) United States
(12) Patent Application Publication
(10) Pub. No.: US 2025/0044742 A1
(43) Pub. Date: Feb. 6, 2025

(54) METRONOME DEVICE WITH REAL TIME FEEDBACK AND METHOD RELATED THERETO

(71) Applicant: Ziv GLOBERMAN, Kfar Shmaryahu (IL)

(72) Inventor: Ziv GLOBERMAN, Kfar Shmaryahu (IL)

(21) Appl. No.: 18/718,127

(22) PCT Filed: Dec. 12, 2022
(86) PCT No.: PCT/IL2022/051309

§ 371 Date: Jun. 10, 2024

Related U.S. Application Data
(60) Provisional application No. 63/288,617, filed on Dec. 12, 2021.

(51) Int. Cl. G04F 5/02

(52) U.S. Cl. CPC G04F 5/025

(57) ABSTRACT

A method which may include, using a computing device operating a processor: based on a signal indicative of detected instrumental sounds, determining a tempo at which a user is playing; and conveying feedback indicative of a difference between the determined tempo and a predefined tempo.

### FIELD OF THE INVENTION

The present invention relates to the field of metronome devices, and more particularly, to metronome devices with real time feedback.

### BACKGROUND OF THE INVENTION

Typically, metronome device generates audible clicks or other sounds at a regular time interval. The audible clicks generated by the metronome are typically used by musicians to practice playing at a desired tempo.

### SUMMARY OF THE INVENTION

Some embodiments of the present invention may provide a method which may include, using a computing device operating a processor: based on a signal indicative of detected instrumental sounds, determining a tempo at which a user is playing; and conveying feedback indicative of a difference between the determined tempo and a predefined tempo.

In some embodiments, determining the tempo at which the user is playing may include: based on the signal indicative of detected instrumental sounds, determining a frequency at which the user is performing actions that cause a musical instrument to generate the detected instrumental sounds; and based on the determined frequency, determining the tempo at which the user is playing.

In some embodiments, determining the tempo at which the user is playing may include: calculating a frequency domain of the signal indicative of the detected instrumental sounds; and based on the calculated frequency domain, determining a frequency at which the user is performing actions that cause the musical instrument to generate the detected instrumental sounds; and based on the determined frequency, determining the tempo at which the user is playing.

In some embodiments, the feedback is indicative of whether the determined tempo is substantially the same as the predefined tempo, slower than the predefined tempo or faster than the predefined tempo.

In some embodiments, the feedback is indicative of the measure of difference between the determined tempo and the predefined tempo.

In some embodiments, conveying the feedback may include: displaying on a screen a line and an index, wherein a relative position of the index with respect to a middle of the line is indicative of whether the determined tempo is slower than the predefined tempo, substantially equal to the predefined tempo or faster than the predefined tempo.

In some embodiments, a distance of the index from the middle of the line is indicative of a measure of the difference between the determined tempo at which the user is playing and the predefined tempo.

In some embodiments, if the determined tempo is substantially equal to the predefined tempo, the method may include displaying the index as aligned with the middle of the line.

In some embodiments, if the determined tempo is slower than the predefined tempo, the method may include displaying the index between a first end and the middle of the line.

In some embodiments, if the determined tempo is faster than the predefined tempo, the method may include displaying the index between a second end and the middle of the line.

In some embodiments, the line is a straight line and the index moves linearly along the line.

In some embodiments, the line is a circular arc line and the index is a hand rotating about a center of a circle defining the circular arc line.

Some embodiments may include, by a speaker: generating a series of audible cues at the predefined tempo.

Some embodiments may include: based on the signal indicative of the detected instrumental sounds, detecting a plurality of structures of a musical composition being played by the user, detecting last sound in each of the structures, calculating a time difference between the detected last sound and last audible cue of generated audible cues, and conveying feedback indicative of the time difference.

Some embodiments may include, by a microphone: detecting the instrumental sounds generated by the musical instrument; and generating the signal indicative of the detected instrumental sounds.

Some embodiments may include conveying the feedback indicative of a difference between the determined tempo and a selected ratio of the predefined tempo.

A device which may include: a processor to: based on a signal indicative of detected instrumental sounds, determine a tempo at which a user is playing; and convey feedback indicative of a difference between the determined tempo and a predefined tempo.

In some embodiments, the processor may be configured to: based on the signal indicative of detected instrumental sounds, determine a frequency at which the user is performing actions that cause a musical instrument to generate the detected instrumental sounds; and based on the determined frequency, determine the tempo at which the user is playing.

In some embodiments, the processor may be configured to: calculate a frequency domain of the signal indicative of the detected instrumental sounds; and based on the calculated frequency domain, determine a frequency at which the user is performing actions that cause the musical instrument to generate the detected instrumental sounds; and based on the determined frequency, determine the tempo at which the user is playing.

In some embodiments, the feedback is indicative of whether the determined tempo is substantially the same as the predefined tempo, slower than the predefined tempo or faster than the predefined tempo.

In some embodiments, the feedback is indicative of the measure of difference between the determined tempo and the predefined tempo.

In some embodiments, the processor may be configured to: display on a screen a line and an index, wherein a relative position of the index with respect to a middle of the line is indicative of whether the determined tempo is slower than the predefined tempo, substantially equal to the predefined tempo or faster than the predefined tempo.

In some embodiments, a distance of the index from the middle of the line is indicative of a measure of the difference between the determined tempo at which the user is playing and the predefined tempo.

In some embodiments, if the determined tempo is substantially equal to the predefined tempo, the processor may be configured to display the index as aligned with the middle of the line.

In some embodiments, if the determined tempo is slower than the predefined tempo, the processor may be configured to display the index between a first end and the middle of the line.

In some embodiments, if the determined tempo is faster than the predefined tempo, the processor may be configured to display the index between a second end and the middle of the line.

In some embodiments, the line is a straight line and the index moves linearly along the line.

In some embodiments, the line is a circular arc line and the index is a hand rotating about a center of a circle defining the circular arc line.

In some embodiments, the device may include: a speaker, wherein the processor may be configured to cause the speaker to generate a series of audible cues at the predefined tempo.

In some embodiments, the processor may be configured to: based on the signal indicative of the detected instrumental sounds, detect a plurality of structures of a musical composition being played by the user; detect last sound in each of the structures; calculate a time difference between the detected last sound and last audible cue of generated audible cues; and convey feedback indicative of the time difference.

In some embodiments, the device may include a microphone configured to: detect the instrumental sounds generated by the musical instrument; and generate the signal indicative of the detected instrumental sounds.

In some embodiments, the processor may be configured to convey the feedback indicative of a difference between the determined tempo and a selected ratio of the predefined tempo.

### BRIEF DESCRIPTION OF THE DRAWINGS

For a better understanding of embodiments of the invention and to show how the same can be carried into effect, reference is made, purely by way of example, to the accompanying drawings in which like numerals designate corresponding elements or sections throughout.

FIG. 1 is a block diagram of an exemplary computing device which may be used with embodiments of the present invention;

FIG. 2 is a schematic illustration of a computing device for determining a difference between a tempo at which a user is playing and a predefined tempo and conveying feedback related thereto, according to some embodiments of the invention;

FIG. 3A is a graph of a time domain of a signal indicative of instrumental sounds generated by the musical instrument, according to some embodiments of the invention;

FIG. 3B is a graph of a frequency domain of the signal indicative of instrumental sounds generated by the musical instrument, according to some embodiments of the invention;

FIG. 4A is a graph showing times at which audible cues indicating the predefined tempo are generated, according to some embodiments of the invention;

FIGS. 4B and 4C are graphs showing times at which the user has performed actions to cause the musical instrument to generate the instrumental sounds, according to some embodiments of the invention;

FIGS. 5A, 5B, 5C and FIGS. 5D, 5E, 5F are schematic illustrations of visual feedback indicative of a difference between a tempo at which a user is playing and a predefined tempo, according to some embodiments of the invention; and

FIG. 6 is a flowchart of a method of determining a difference between a tempo at which a user is playing and a predefined tempo and conveying feedback related thereto, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Embodiments of the present invention may improve functionality of metronome devices by providing feedback (e.g., a real time feedback) indicative of whether or not a user (e.g., a musician) is playing at a tempo that is slower than a predefined tempo, equal (or substantially equal) to the predefined tempo or faster than the predefined tempo.

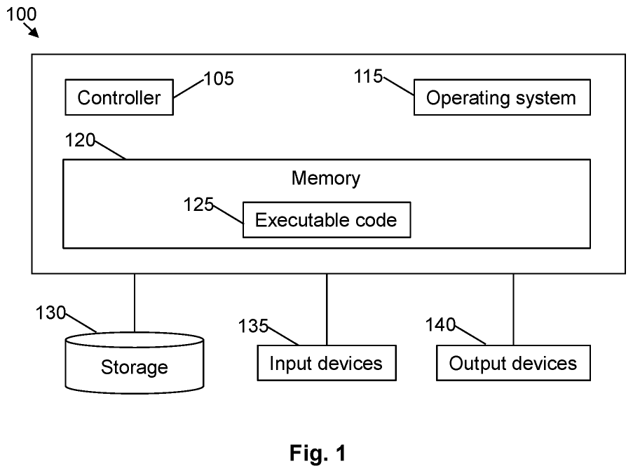

Reference is made to FIG. 1, which is a block diagram of an exemplary computing device which may be used with embodiments of the present invention.

Computing device 100 may include a controller or processor 105 that may be, for example, a central processing unit processor (CPU), a chip or any suitable computing or computational device, an operating system 115, a memory 120, a storage 130, input devices 135 and output devices 140.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different, memory units. Memory 120 may store for example, instructions to carry out a method (e.g., code 125), and/or data such as user responses, interruptions, etc.

Executable code 125 may be any executable code, e.g., an application, a program, a process, task or script. Executable code 125 may be executed by controller 105 possibly under control of operating system 115. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the present invention by for example executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

In some embodiments, some of the components shown in FIG. 1 may be omitted.

Embodiments of the invention may include one or more article(s) (e.g., memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

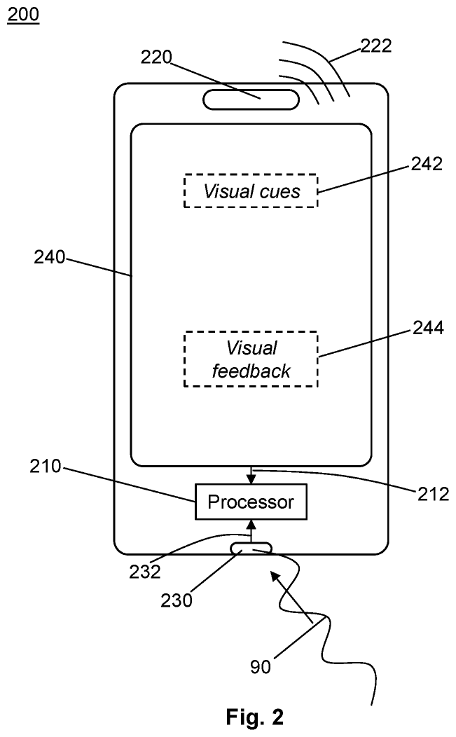

Reference is made to FIG. 2, which is a schematic illustration of a computing device 200 for determining a difference between a tempo at which a user is playing and a predefined tempo and conveying feedback related thereto, according to some embodiments of the invention.

Computing device 200 may include a processor 210, a speaker 220, a microphone 230 and a screen 240. Computing device 200 may be, for example, a smartphone or any other suitable computing device.

Processor 210 may receive as an input 212, for example via a screen (e.g., touch screen) or any other suitable input device, a predefined tempo at which a user (e.g., a musician) is expected to play a piece of a musical composition using a musical instrument. Processor 210 may cause speaker 220 to generate a series of audible cues 222 at the predefined tempo, for example to convey to the user an indication of the speed (or rate) at which the user is expected to play the piece of the musical composition using the musical instrument. Processor 210 may cause display 240 to present a series of visible cues 242 at the predefined tempo.

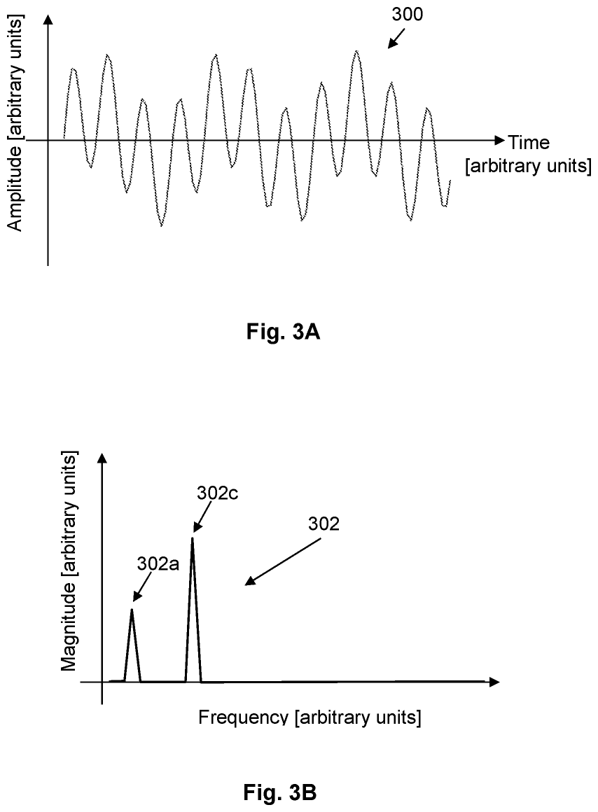

The user may play the piece of the musical composition using the musical instrument that may generate or produce instrumental sounds 90. Microphone 230 of computing device 200 may detect instrumental sounds 90 generated by the musical instrument. Based on detected instrumental sounds 90, microphone 230 may generate an electric signal 232 indicative of detected instrumental sounds 90. Instrumental sounds 90 and signal 232 may include information indicative of a frequency of a sound generated by components of the musical instrument (e.g., by strings of a guitar, a membrane of a drum, air columns of a woodwind instrument or any other suitable components of any other suitable instrument; e.g., such as a frequency 302a described hereinbelow with respect to FIG. 3B). Instrumental sounds 90 and signal 232 may also include information indicative of a frequency at which the user is performing actions that cause the musical instrument to generate instrumental sounds 90 (e.g., the frequency at which the user touches the strings of the guitar, hits the membrane of the drum, presses keys of the woodwind instrument or any other suitable action that cause any other suitable musical instrument to generate instrumental sounds; e.g., such as a frequency 302c described hereinbelow with respect to FIG. 3B). The actions performed by the user that cause the musical instrument to generate or produced instrumental sounds 90 are also referred herein as strokes.

Processor 210 may receive from microphone 230 signal 232 indicative of detected instrumental sounds 90. Based on signal 232, processor 210 may determine the frequency at which the user is performing actions that cause the musical instrument to generate instrumental sounds 90 (e.g., the frequency of strokes). For example, processor 210 may calculate a frequency domain of signal 232 by applying, e.g., a Fourier transform (FT), a discrete Fourier transform (DFT), a fast Fourier transform (FFT) or any other suitable frequency domain transformation on signal 232 (e.g., a frequency domain 302 as described hereinbelow). Based on the calculated frequency domain, processor 210 may determine the frequency at which the user is performing actions that cause the musical instrument to generate instrumental sounds 90 (e.g., the frequency of strokes). Based on the determined frequency at which the user is performing actions that cause the musical instrument to generate instrumental sounds 90 (e.g., the frequency of strokes), processor 210 may determine a tempo at which the user is playing. The tempo at which the user is playing and the frequency at which the user is performing actions that cause the musical instrument to generate instrumental sounds 90 (e.g., the frequency of strokes) may vary with time. Processor 210 may determine an average frequency at which the user is performing actions that cause the musical instrument to generate instrumental sounds 90 (e.g., an average frequency of strokes) and an average tempo at which the user is playing. The average frequency of strokes and the average tempo may be calculated over a selected time interval (e.g., over a few seconds or any other suitable time interval).

Processor 210 may determine a difference between (i) the tempo and/or the average tempo at which the user is playing and (ii) the predefined tempo. Processor 210 may convey feedback indicative of the difference between (i) the tempo and/or the average tempo at which the user is playing and (ii) the predefined tempo. For example, processor 210 may cause screen 240 to display visual feedback 244 indicative of the difference between (i) the tempo and/or the average tempo at which the user is playing and (ii) the predefined tempo. For example, processor 210 may determine whether or not the tempo and/or the average tempo at which the user is playing is slower than the predefined tempo, equal (or substantially equal) to the predefined tempo or faster than the predefined tempo and convey the respective feedback to the user. Processor 210 may convey the feedback in real time (or substantially in real time). For example, the feedback may be conveyed while the user is playing the musical composition.

Based on signal 232, processor 210 may detect a plurality of structures of the musical composition being played by the user. Processor 210 may detect last sound in each of the structures, calculate a time difference between the detected last sound and last audible cue of generated audible cues 222, and convey feedback (e.g., visual feedback) indicative of the time difference to the user. Processor 210 may calculate an average time difference over a selected time interval and convey feedback (e.g., visual feedback) indicative of the average time difference to the user.

Reference is made to FIG. 3A, which is a graph of a time domain 300 of a signal indicative of instrumental sounds 90 generated by the musical instrument, according to some embodiments of the invention.

Reference is also made to FIG. 3B, which is a graph of a frequency domain 302 of the signal indicative of instrumental sounds 90 generated by the musical instrument, according to some embodiments of the invention.

FIG. 3A shows a graph of a time domain 300 of the signal indicative of instrumental sounds 90 generated by the musical instrument (e.g., such as signal 232 described hereinabove) and FIG. 3B shows a graph of a frequency domain 302 of the signal. Frequency domain 302 may be calculated by processor 210 of computing device 200 by applying a frequency domain transformation on time domain 300 of the signal (e.g., as described hereinabove). As described hereinabove, the signal may include information indicative of a frequency 302a (as indicated in frequency domain 302 of the signal in FIG. 3B) of the sound generated by components of the musical instrument. The signal may also include information indicative of a frequency 302c (as indicated in frequency domain 302 of the signal in FIG. 3B) at which the user is performing actions that cause the musical instrument to generate instrumental sounds 90 (e.g., the frequency of strokes). Based on frequency 302c at which the user is performing actions that cause the musical instrument to generate instrumental sounds 90 (e.g., the frequency of strokes), processor 210 of computing device 200 may determine the actual tempo at which the user is playing and the difference between the actual tempo and the predefined tempo and further convey the respective feedback to the user (e.g., as described hereinabove).

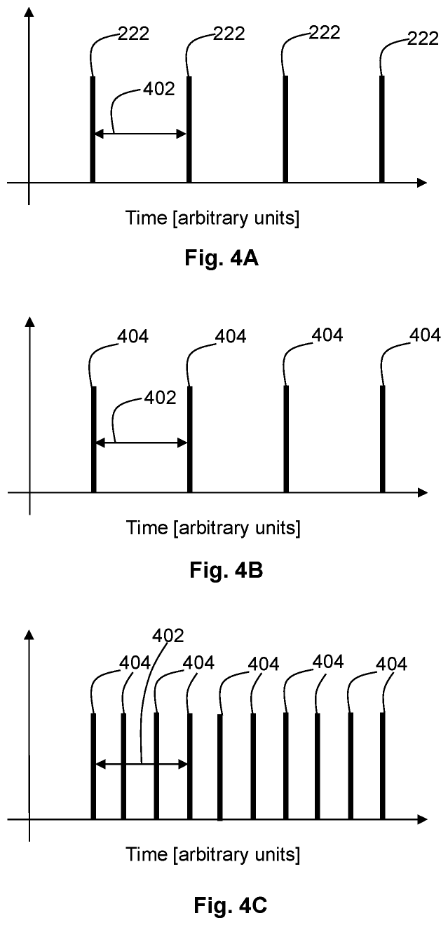

When playing a musical composition, the user may be required to play at the tempo that is the same (or substantially the same) as the predefined tempo (e.g., as indicated by audible cues 222 generated at a predefined time interval) or at a selected ratio of the predefined tempo (e.g., as described hereinbelow with respect to FIGS. 4A to 4C).

Reference is made to FIG. 4A, which is a graph showing times at which audible cues 222 indicating the predefined tempo are generated (e.g., by computing device 200 or other suitable metronome device), according to some embodiments of the invention.

A time difference between two subsequent audible cues 222 is referred herein as a beat 402 (e.g., as shown in FIG. 4A).

Reference is also made to FIGS. 4B and 4C, which are graphs showing times at which the user has performed actions to cause the musical instrument to generate instrumental sounds 90 (e.g., strokes 404), according to some embodiments of the invention.

The occurrence of strokes 404 may be determined based on the determined frequency of strokes (e.g., determined frequency of actions performed by the user to cause to the musical instrument to generate instrumental sounds 90; e.g., as described hereinabove with respect to FIG. 2 and FIGS. 3A-3B) and/or based on the change (e.g., increase) of the amplitude of already determined or known frequency of strokes.

As mentioned hereinabove, the user may play at the tempo that is the same (or substantially the same) tempo as the predefined tempo, for example one stroke 404 for each beat 402 as shown in FIG. 4B. The user may also play at the tempo that is a selected ratio of the predefined tempo. For example, the user may play at the tempo that is higher than the predefined tempo, for example four strokes 404 per beat 402 as shown in FIG. 4C or any other suitable number of strokes 404 per beat 402 (e.g., two, three, five or more strokes 404 per beat 402). In another example, the user may play at the tempo that is slower than the predefined tempo (e.g., one stroke 404 each two, three, four any other suitable number of beats 402).

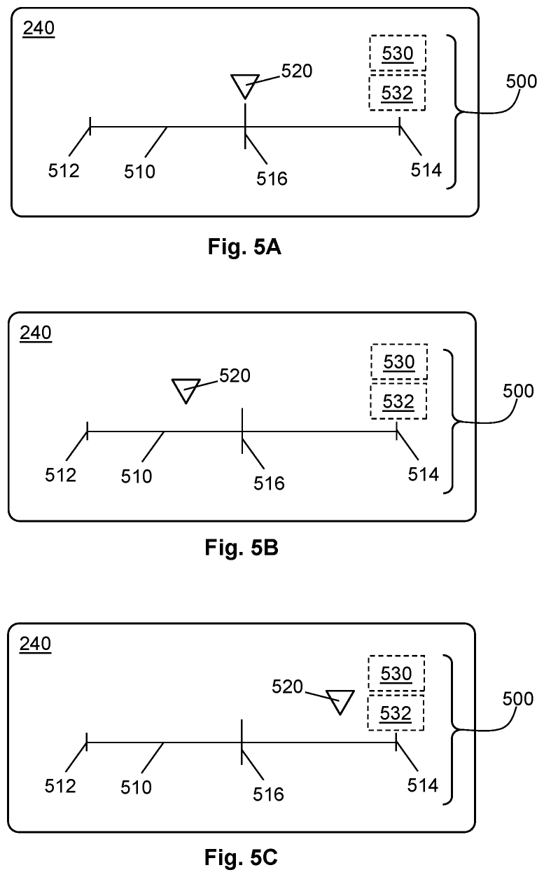

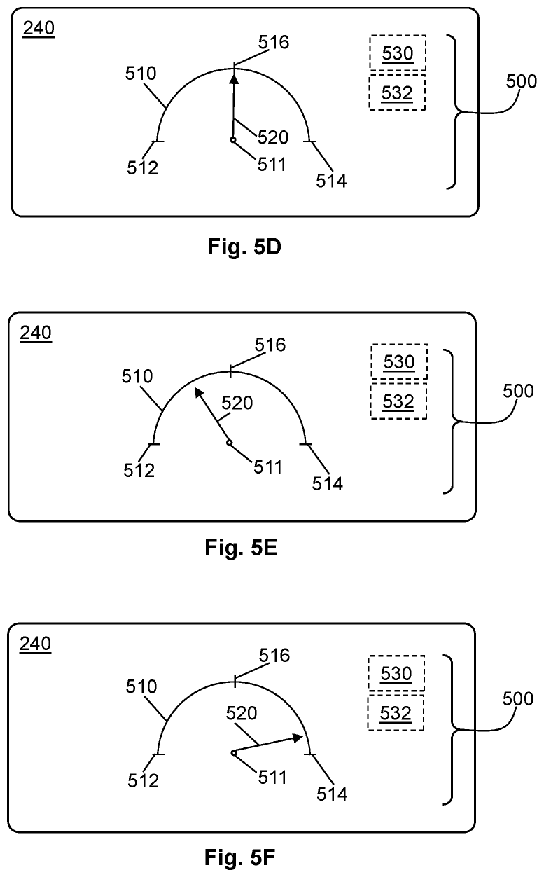

If the user is expected to or is planning to play the musical composition at the tempo that is a selected ratio of the predefined tempo, processor 210 of computing device 200 may receive the selected ratio as an input and account for the selected ratio when determining and conveying feedback 244. For example, processor 210 may determine a difference between (i) the tempo and/or the average tempo at which the user is playing and (ii) the selected ratio of the predefined tempo and convey respective feedback 244 (e.g., as described hereinabove with respect to FIG. 2) or feedback 500 (e.g., as described hereinbelow with respect to FIGS. 5A to 5C).

Reference is made to FIGS. 5A, 5B, 5C and FIGS. 5D, 5E, 5F, which are schematic illustrations of visual feedback 500 indicative of the difference between the tempo at which the user is playing and the predefined tempo, according to some embodiments of the invention. Visual feedback 500 may be generated by processor 210 and displayed on screen 240 of computing device 200, e.g., as described above with respect to FIG. 2. Visual feedback 500 may include a line or bar 510. Line 510 may include a first end 512, a second end 514 and a midline marking 516 representing the middle of line 510 with respect to first end 512 and second end 514 of line 510. Line 510 may be a horizontal line (e.g., as shown in FIGS. 5A, 5B and 5C) or a vertical line. Visual feedback 500 may include an index or pointer 520 indicating the tempo and/or the average at which the user is playing (e.g., calculated based on the determined frequency and/or the determined average frequency at which the user is performing actions that cause the musical instrument to generate instrumental sounds 90 (e.g., the frequency of strokes), as described hereinabove). The relative position of index 520 with respect to the middle of line 510 (e.g., indicated by midline marking 516) may indicate whether the user is playing at a tempo that is slower than the predefined tempo (and/or the selected ratio thereof), equal (or substantially equal) to the predefined tempo (and/or the selected ratio thereof) or faster than the predefined tempo (and/or the selected ratio thereof).

For example, if it is determined by processor 210 that the user is playing at the tempo that is equal (or substantially equal) to the predefined tempo (and/or the selected ratio thereof), index 520 may be displayed as aligned with the middle of line 510 (e.g., indicated by midline marking 516, for example as shown in FIG. 5A). If it is determined by processor 210 that the user is playing at the tempo that is slower than the predefined tempo (and/or the selected ratio thereof), index 520 may be displayed between first end 512 and the middle of line 510 (e.g., on the left side of midline marking 516, for example as shown in FIG. 5B). If it is determined by processor 210 that the user is playing at the tempo that is faster than the predefined tempo (and/or the selected ratio thereof), index 520 may be displayed between second end 514 and the middle of line 510 (e.g., on the right side of midline marking 516, for example as shown in FIG. 5C).

The distance between index 520 and the middle of line 510 (e.g., indicated by midline marking 516) may be indicative of the measure of the difference of the tempo and/or the average tempo at which the user is playing with respect to the predefined tempo (and/or the selected ratio thereof). For example, the greater the distance of index 520 from the middle of line 510 (e.g., indicated by midline marking 516), the greater the difference of the tempo and/or the average tempo at which the user is playing with respect to the predefined tempo (and/or the selected ratio thereof).

While in the example of FIGS. 5A, 5B and 5C, midline marking 516 is used to indicate the predefined tempo (and/or the selected ratio thereof), indication of the predefined tempo (and/or the selected ratio thereof) may be made with respect to any other suitable reference point along line 510.

Visual feedback 500 may include a numeral value 530 indicating the tempo and/or the average tempo at which the user is playing (e.g., calculated based on the determined frequency and/or the determined average frequency at which the user is performing actions that cause the musical instrument to generate instrumental sounds 90 (e.g., the frequency of strokes), as described hereinabove). Visual feedback 500 may include a numeral value 532 indicating a standard deviation of the determined tempos. Line 510 may include markings indicating the ratio between (i) the predefined tempo (and/or the selected ratio thereof) and (ii) the actual tempo and/or the average actual tempo at which the user is playing.

In the example of FIGS. 5A, 5B and 5C, line 510 is a straight line and index or pointer 520 moves linearly along line 510 to indicate whether the user is playing at the predefined tempo (and/or the selected ratio thereof), slower than the predefined tempo (and/or the selected ratio thereof) or faster than the predefined tempo (and/or selected ratio thereof). In another example, e.g., as shown in FIGS. 5D, 5E and 5F, line 510 is a circular arc line and index or pointer 520 is a hand rotating about a center 511 of a circle defining line 510. In the example of FIGS. 5D, 5E and 5F, the angular position of index 520 with respect to midline marking 516 of line 510 or any other suitable reference point along line 510 may indicate whether indicate whether the user is playing at the predefined tempo (and/or the selected ratio thereof), slower than the predefined tempo (and/or the selected ratio thereof) or faster than the predefined tempo (and/or selected ratio thereof). The angular distance between index 520 and the middle of line 510 or any other suitable reference point along line 510 may be indicative of the measure of the difference of the tempo and/or the average tempo at which the user is playing with respect to the predefined tempo (and/or the selected ratio thereof).

Visible feedbacks other than visual feedback 500 may be conveyed to the user to indicate the difference between the tempo at which the user is playing and the predefined tempo.

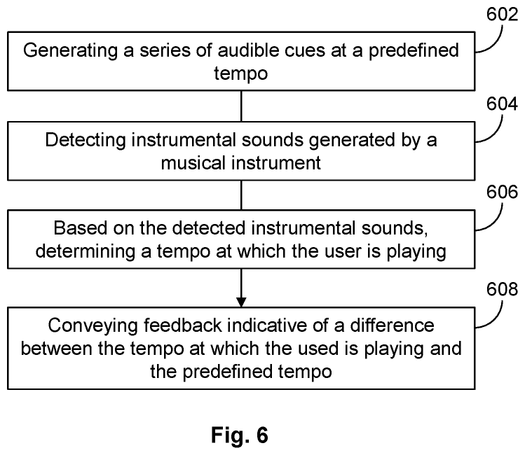

Reference is made to FIG. 6, which is a flowchart of a method of determining a difference between a tempo at which the user is playing and a predefined tempo and conveying feedback related thereto, according to some embodiments of the invention.

Operations described below with respect to FIG. 6 may be performed with computing device 100 or computing device 200 described hereinabove. However, other equipment may be used.

In operation 602, a series of audible cues (e.g., audible cues 222) may be generated at a predefined tempo by a speaker (e.g., speaker 220). The series of the audible cues may convey to the user an indication of the speed at which the user is expected to play the piece of the musical composition using the musical instrument. In some embodiments, a series of visible cues (e.g., series of visible cues 242) may be displayed on a screen.

In operation 604, instrumental sounds (e.g., instrumental sounds 90) generated by a musical instrument may be detected by a microphone (e.g., microphone 230).

In operation 606, based on a signal indicative of the detected instrumental sounds (e.g., signal 232), a tempo at which the user is playing may be determined by a processor (e.g., processor 210). For example, a frequency domain of the signal may be calculated by the processor by applying, e.g., a fast Fourier transform (FFT) or any other suitable frequency domain transformation on the signal. Based on the calculated frequency domain, a frequency at which the user is performing actions that cause the musical instrument to generate the instrumental sounds (e.g., the frequency of strokes) may be determined by the processor (e.g., as described hereinabove). Based on the determined frequency at which the user is performing actions that cause the musical instrument to generate the instrumental sounds (e.g., the frequency of strokes), the tempo at which the user is playing may be determined by the processor (e.g., as described hereinabove). In some embodiments, an average tempo at which the user is playing over a selected time interval may be determined by the processor (e.g., as described hereinabove).

In operation 608, feedback indicative of a difference between the tempo and/or the average tempo at which the user is playing and the predefined tempo (and/or the selected ratio of the predefined tempo) may be conveyed by the processor (e.g., visual feedback 244 or 500 as described hereinabove). The feedback may be conveyed in real time (or substantially in real time), e.g., while the user is playing the musical composition. For example, it may be determined by the processor whether or not the tempo and/or the average tempo at which the user is playing is slower than the predefined tempo (and/or the selected ratio thereof), equal (or substantially equal) to the predefined tempo (and/or the selected ratio thereof) or faster than the predefined tempo (and/or the selected ratio thereof) and the respective feedback may be conveyed to the user (e.g., as described hereinabove).

Conveying the feedback may, for example, include displaying on the screen, a line (e.g., line 510) and an index (e.g., index 520), wherein the relative position of the index with respect to the middle of the line (e.g., as indicated by midline marking 516) may be indicative of the difference between the tempo and/or the average tempo at which the user is playing and the predefined tempo (and/or the selected ratio thereof). For if the user is playing at the tempo that is equal (or substantially equal) to the predefined tempo (and/or the selected ratio thereof), the index may be displayed aligned with the middle of the line (e.g., as described above with respect to FIG. 5A). If the user is playing the tempo that is slower than the predefined tempo (and/or the selected ratio thereof), the index may be displayed between a first end (e.g., first end 512) and the middle of the line (e.g., as described above with respect to FIG. 5B). If the user is playing at the tempo that is greater than the predefined tempo (and/or the selected ratio thereof), the index may be displayed between a second end (e.g., second end 514) and the middle of the line (e.g., as described above with respect to FIG. 5C). The distance between the index and the middle of the line may be indicative of the measure of the difference between the tempo and/or the average tempo at which the user is playing and the predefined tempo (and/or the selected ratio thereof) (e.g., as described hereinabove).

Based on the signal indicative of the detected instrumental sounds, structures of the musical composition being played by the user may be detected by the processor. A time difference between the detected last sound and last audible cue of the generated audible cues may be calculated by the processor, and feedback (e.g., visual feedback) indicative of the time difference may be conveyed to the user by the processor. In some embodiments, an average time difference over a selected time interval may be calculated and feedback (e.g., visual feedback) indicative of the average time difference may be conveyed to the user by the processor.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A method comprising, using a computing device operating a processor:
based on a signal indicative of detected instrumental sounds, determining a tempo at which a user is playing; and
conveying feedback indicative of a difference between the determined tempo and a predefined tempo.

2. The method of claim 1, wherein determining the tempo at which the user is playing comprising:
based on the signal indicative of detected instrumental sounds, determining a frequency at which the user is performing actions that cause a musical instrument to generate the detected instrumental sounds; and
based on the determined frequency, determining the tempo at which the user is playing.

3. The method of claim 1, wherein determining the tempo at which the user is playing comprising:
calculating a frequency domain of the signal indicative of the detected instrumental sounds; and
based on the calculated frequency domain, determining a frequency at which the user is performing actions that cause the musical instrument to generate the detected instrumental sounds; and
based on the determined frequency, determining the tempo at which the user is playing.

4. The method of claim 1, wherein the feedback is indicative of at least one of: (i) whether the determined tempo is substantially the same as the predefined tempo, slower than the predefined tempo or faster than the predefined tempo, and (ii) a measure of difference between the determined tempo and the predefined tempo.

5. (canceled)

6. The method of claim 1, wherein conveying the feedback comprises:
displaying on a screen a line and an index,
wherein a relative position of the index with respect to a middle of the line is indicative of whether the determined tempo is slower than the predefined tempo, substantially equal to the predefined tempo or faster than the predefined tempo.

7. The method of claim 6, wherein a distance of the index from the middle of the line is indicative of a measure of the difference between the determined tempo at which the user is playing and the predefined tempo.

8. The method of claim 6, wherein:
if the determined tempo is substantially equal to the predefined tempo, displaying the index as aligned with the middle of the line,
if the determined tempo is slower than the predefined tempo, displaying the index between a first end and the middle of the line, and
if the determined tempo is faster than the predefined tempo, displaying the index between a second end and the middle of the line.

9. (canceled)

10. (canceled)

11. The method of claim 6, wherein the line is a straight line and the index moves linearly along the line.

12. The method of claim 6, wherein the line is a circular arc line and the index is a hand rotating about a center of a circle defining the circular arc line.

13. The method of claim 1, comprising, by a speaker:
generating a series of audible cues at the predefined tempo,
based on the signal indicative of the detected instrumental sounds, detecting a plurality of structures of a musical composition being played by the user,
detecting last sound in each of the structures,
calculating a time difference between the detected last sound and last audible cue of generated audible cues, and
conveying feedback indicative of the time difference.

14. (canceled)

15. (canceled)

16. The method of claim 1, comprising conveying the feedback indicative of a difference between the determined tempo and a selected ratio of the predefined tempo.

17. A device comprising:
a processor to:
based on a signal indicative of detected instrumental sounds, determine a tempo at which a user is playing; and
convey feedback indicative of a difference between the determined tempo and a predefined tempo.

18. The device of claim 17, wherein the processor is configured to:
based on the signal indicative of detected instrumental sounds, determine a frequency at which the user is performing actions that cause a musical instrument to generate the detected instrumental sounds; and
based on the determined frequency, determine the tempo at which the user is playing.

19. The device of claim 17, wherein the processor is configured to:
calculate a frequency domain of the signal indicative of the detected instrumental sounds; and
based on the calculated frequency domain, determine a frequency at which the user is performing actions that cause the musical instrument to generate the detected instrumental sounds; and
based on the determined frequency, determine the tempo at which the user is playing.

20. The device of claim 17, wherein the feedback is indicative of at least one of: (i) whether the determined tempo is substantially the same as the predefined tempo, slower than the predefined tempo or faster than the predefined tempo, and (ii) a measure of difference between the determined tempo and the predefined tempo.

21. (canceled)

22. The device of claim 17, wherein the processor is configured to:
display on a screen a line and an index,
wherein a relative position of the index with respect to a middle of the line is indicative of whether the determined tempo is slower than the predefined tempo, substantially equal to the predefined tempo or faster than the predefined tempo.

23. The device of claim 22, wherein a distance of the index from the middle of the line is indicative of a measure of the difference between the determined tempo at which the user is playing and the predefined tempo.

24. The device of claim 22, wherein:
if the determined tempo is substantially equal to the predefined tempo, the processor is configured to display the index as aligned with the middle of the line,
if the determined tempo is slower than the predefined tempo, the processor is configured to display the index between a first end and the middle of the line, and
if the determined tempo is faster than the predefined tempo, the processor is configured to display the index between a second end and the middle of the line.

25. (canceled)

26. (canceled)

27. The device of claim 22, wherein the line is a straight line and the index moves linearly along the line.

28. The device of claim 22, wherein the line is a circular arc line and the index is a hand rotating about a center of a circle defining the circular arc line.

29. The device of claim 17, comprising:
a speaker,
wherein the processor is configured to:
cause the speaker to generate a series of audible cues at the predefined tempo,
based on the signal indicative of the detected instrumental sounds, detect a plurality of structures of a musical composition being played by the user;
detect last sound in each of the structures;
calculate a time difference between the detected last sound and last audible cue of generated audible cues; and
convey feedback indicative of the time difference.

30. (canceled)

31. The device of claim 17, comprising a microphone configured to:
detect the instrumental sounds generated by the musical instrument; and
generate the signal indicative of the detected instrumental sounds.

32. The device of claim 17, wherein the processor is configured to convey the feedback indicative of a difference between the determined tempo and a selected ratio of the predefined tempo.
